(19) United States
(12) Patent Application Publication
(10) Pub. No.: US 2009/0004244 A1
(43) Pub. Date: Jan. 1, 2009

(54) Iris design as a drug depot for zonal drug delivery by contact lens

(76) Inventors: Werhner C. Orilla, Anaheim, CA (US); James A. Burke, Santa Ana, CA (US)

Correspondence Address: Brent A. Johnson;Allergan, Inc. (T2-7H), 2525 Dupont Drive, Irvine, CA, 92612, US

(21) Appl. No.: 11/823,471

(22) Filed: Jun. 27, 2007

(51) Int. Cl. G02C 7/04

(52) U.S. Cl. 424/429

(57) ABSTRACT

A contact lens providing zonal drug delivery includes a lens body having an optical axis and an opaque simulated iris pattern applied to the lens body, about the optical axis, with the pattern including an ophthalmic drug.

The present invention is generally related to a delivery vehicle for dispensing therapeutic drugs and is more particularly directed to a biocompatible contact lens incorporating drugs in a manner enabling a sustained and effective dose release through the cornea and other surrounding tissue while at the same time providing a colored iris pattern integrated into the contact lens in order that the eye appears more normal.

Drug loaded contact lenses have been described in the art, see for example U.S. Ser. No. 11/594,518 to Orilla, Burke, and Robinson. This application is to be incorporated herein in its entirety by this specific reference thereto.

Opaque and/or different colored drugs embedded in a contact lens body may be clearly seen by observers of the contact lens user and this appears un-natural.

On the other hand, colored contact lens have been disposed on the eye in an effort to alter the apparent color of the user's iris. See, for example U.S. Pat. Nos. 6,890,075 and 6,774,178. These patents are to be incorporated in their entirety into the present application by this specific reference thereto for the purpose of showing how colors may be incorporated into contact lens.

In addition, “soft contact lenses” have been utilized as a drug delivery vehicle. Soft contact lenses are formed from a highly porous plastic which can absorb water or other fluids and accordingly by saturating the lens with a fluid medication and inserting the lens into the eye a dosage of medication is provided in the eye by the lacrimal fluids. Unfortunately, these simple devices do not provide a proper control sustained release of the medication.

Other soft contact lenses have utilized a polymeric plastic in which a reservoir or medication is held, for example, U.S. Pat. Nos. 3,618,604 and 3,828,777. In these devices, the polymeric material is designed to control the release rate of the medication and thus provide a more uniform level of medication within the eye for extended periods of time.

In order to maintain clarity of vision, other medication delivering contact lenses have been developed with transparent central optic areas and peripheral areas with a drug embedded therein as in U.S. Pat. No. 3,786,812.

However, none of these devices have provided for zonal delivery of a drug which may be necessary in instances such as lowering of intra ocular pressure (IOP) and at the same time provide for a natural appearance of the eye through the use of colored pigment pattern embedded into the contact lens to mask or color accommodate for coloration added by the drug.

### SUMMARY OF THE INVENTION

A contact lens in accordance with the present invention generally includes a lens body having an optical axis along with an opaque simulated iris pattern disposed about the optical axis.

More particularly, the ophthalmic drug may be asymmetrically disposed within the iris pattern about the optical axis.

The ophthalmic drug may be disposed in an upper hemispherical region of the lens body and further a weighted portion of the iris pattern be provided for maintaining a presence of the lens body upper hemispheric region in position with an upper hemispherical region of the user's eye.

### BRIEF DESCRIPTION OF THE DRAWINGS

The present invention may be more clearly understood with reference to the following detailed description in connection, in which:

FIG. 1 is a plan view representing a contact lens body with a drug loaded colored simulated iris layer or pattern; and

FIG. 2 is a plan view of a contact lens body having representation of an asymmetrically disposed iris pattern with a weighted portion.

### DETAILED DESCRIPTION

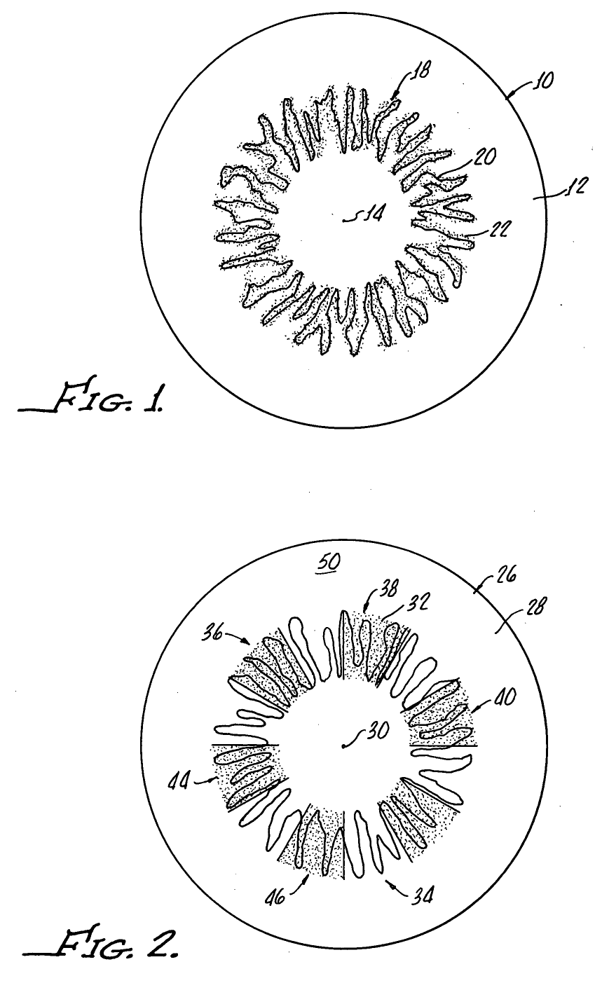

With reference to FIG. 1, there is shown a plan view representation of a contact lens for providing ocular drug delivery with the contact lens 10 including a lens body 12 with an optical axis 14 along with a simulated iris pattern 18 applied to the lens body 12 about the optical axis 14.

The iris pattern 18 may include a separate ink 20 along with an ophthalmic drug 22 interspersed between the ink 20. Alternatively, the ink 20 and drug 22 may be mixed or applied in identical pattern with the ink 20 and drug 22 overlaying one another. The application of the iris pattern is described in U.S. Pat. No. 6,890,075 has been incorporated herein for the purpose of describing the introduction of a plurality of pattern elements of different colors to a lens body.

As shown in FIG. 1, the drug 22 may be symmetrically disposed on the lens body 12 about the optical axis 14.

Alternatively, as represented in FIG. 2, a lens 26 may include a lens body 28 having an optical axis 30 in which the ophthalmic drug may be asymmetrically disposed within the iris pattern in upper hemispherical segments 36, 38, 40.

Corresponding segments 44, 46, 48 disposed in a lower hemispherical portion of the iris pattern 34 may include inert particles to provide a weighted portion of the iris pattern 34 in order to maintain a presence of the upper hemispherical region 50 in position with an upper hemispherical region of a user's eye (not shown). It should be appreciated that any configuration suitable with weights including size, shape, and number may be utilized in the segments 44, 46, 48. Disposing the drug in the upper hemispherical region 50 enhances downward draining of the released drug which reduces wash and provides a greater response of the eye to the drug.

Suitable drugs for use in the present invention include any suitable ophthalmic drug, for example intraocular pressure lowering drugs such as Brimonidine and Lumigan®, a bimatoprost ophthalmic solution.

Suitable materials for use in the present invention may include non-hydrophilic materials which include silicones such as unrestricted platinum fast-cure Nusil MED1-4213 and MED2-4123 and unrestricted Nusil low and high consistency elastomers with platinum cure systems. Alternatively, medical grade silicone commercially available may also be used as well as conventional hydrogel polymers.

Hydrophilic materials suitable for use in the present invention may include: low water content, high-ionic polymers (e.g. Crofilcon); high water contact, high-ionic polymers (e.g. Lidofilcon); lower water content, ionic polymers (e.g. Balafilcon); and high water contact, ionic polymers (e.g. Etafilcon A).

Although there has been hereinabove described a specific iris design as a drug depot for zonal drug delivery by contact lens in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A contact lens providing zonal drug delivery, said contact lens comprising:
a lens body having an optical axis; and
an opaque simulated iris pattern applied to said lens body, about said optical axis, the pattern including an ophthalmic drug.

2. The lens according to claim 1 wherein said ophthalmic drug is asymmetrically disposed within the iris pattern about said optical axis.

3. The lens according to claim 1 wherein said pattern further include an ink mixed with said ophthalmic drug.

4. The lens according to claim 2 wherein the asymmetrically disposed ophthalmic drug is disposed in an upper hemispherical region of the lens body.

5. The lens according to claim 4 further comprising a weighted portion of the iris pattern for maintaining a presence of the upper hemispherical region of the lens body in position with an upper hemispherical region of a user's eye.

6. A contact lens providing zonal drug delivery, said contact lens comprising:
a lens body having an optical axis; and
a simulated iris pattern applied to said lens body about said optical axis, said iris pattern comprising an ink and an ophthalmic drug.

7. The lens according to claim 6 wherein said ink is asymmetrically disposed around said optical axis within the iris pattern and said ophthalmic drug is asymmetrically disposed around said optical axis within the iris pattern.

8. The lens according to claim 7 wherein the asymmetrical disposed ophthalmic drug is present in an upper hemispherical region of the lens body.

9. The lens according to claim 9 further comprises a weighted portion of the iris pattern for maintaining a pressure of the upper hemispherical region of the lens body in position with an upper hemispherical region of a user's eye.
